(19) United States
(12) Patent Application Publication
(10) Pub. No.: US 2014/0158177 A1
(43) Pub. Date: Jun. 12, 2014

(54) PRODUCING CURRENT THAT IS NOT ESSENTIALLY STEADY DIRECT CURRENT

(71) Applicants: Joseph M. Zlotnicki, Downers Grove, IL (US); Thomas J. Phillips, Chapel Hill, NC (US)

(72) Inventors: Joseph M. Zlotnicki, Downers Grove, IL (US); Thomas J. Phillips, Chapel Hill, NC (US)

(73) Assignee: Green Light Industries, Inc.

(21) Appl. No.: 14/101,558

(22) Filed: Dec. 10, 2013

Related U.S. Application Data
(60) Provisional application No. 61/735,735, filed on Dec. 11, 2012.

(51) Int. Cl. H01L 31/042; H01L 31/18; H01L 35/32

(52) U.S. Cl. CPC H01L 31/0428; H01L 35/32; H01L 31/18
USPC 136/201; 136/206; 136/259; 438/57

(57) ABSTRACT

A machine, manufacture, article, process, and product produced thereby, as well as necessary intermediates, which in some cases, pertains to power sources, units thereof, etc. Illustratively, the machine can include a convertor, such as a photovoltaic cell, located to produce current that is not essentially steady direct current by repeatedly shadowing the photovoltaic convertor from exposure to radiation such that at least some of the radiation shadowed from the photovoltaic convertor either produces electricity or is reflected to an emitter which subsequently reemits radiation to the photovoltaic convertor or to another photovoltaic convertor.

### I. PRIORITY STATEMENT

The present patent application claims benefit from U.S. Ser. No. 61/735,735, filed on Dec. 11, 2012, being incorporated by reference completely as if restated totally herein.

### II. TECHNICAL FIELD

The technical field includes machine, manufacture, article, process, and product produced thereby, as well as necessary intermediates, which in some cases, pertains to power sources, units thereof, etc.

### III. SUMMARY

Depending on the implementation, there is a machine, article of manufacture, method for use and method of making, and corresponding products produced thereby, as well as necessary intermediates and components, regarding a current source that includes current that is not essentially steady direct current, etc.

### IV. BRIEF DESCRIPTION OF THE DRAWINGS

FIG. 1 is an illustration to teach embodiments which include a current source.

FIG. 2 is an illustration to teach embodiments which include a current source.

FIG. 3 is an illustration to teach embodiments which include a current source.

FIG. 4 is an illustration to teach embodiments which include a current source in an operational mode.

FIG. 5 is an illustration to teach embodiments which include a current source in a standby mode.

FIG. 6 is an illustration to teach embodiments which include multiple supports for convertors and/or reflectors.

FIG. 7 is an illustration of an IV curve.

FIG. 8 is an illustration to teach embodiments of a vane shadowing convertors.

FIG. 9 is an illustration to teach embodiments of another vane shadowing convertors.

FIG. 10 is an illustration to teach embodiments of yet another vane shadowing convertors.

FIG. 11 is an illustration to teach embodiments of still another vane shadowing convertors and having openings that do not shadow the convertors.

FIG. 12 is an illustration to teach embodiments of vane shadowing patterns.

FIG. 13 is an illustration to teach embodiments of components with respect to at least one of each of an emitter, vane, and convertor.

### V. MODES

In alternating current (AC), the movement of an electric charge reverses direction whereas in direct current (DC), the movement of an electric charge is only in one direction; current is accompanied (or caused) by the voltage(s). For perspective, AC is the form of current in which electric power is delivered to most businesses and residences from the grid; DC is the form of current in which electric power is delivered to a flashlight bulb by a battery. The usual AC wave form is more or less sinusoidal, though in certain applications, variations on the sinusoidal form and frequency can be used, such as substantially triangular or substantially square wave form or other less geometric forms tailored to a device requirement. AC or DC can be variable, and AC or DC can be pulsating, i.e., with a periodicity. For example, a DC generator can be randomly throttled so that it produces a variable DC, or it can be throttled with a periodicity (e.g., for a maximum for the period of, say, one minute or less), thereby producing a pulsating DC. Intermittent current can generally be considered DC that is interrupted at intervals, and AC is a type of intermittent current. The intermittency can be periodic or not.

Many aspects of the electrical power infrastructure and applications can use alternating current to enable stepping voltage up or down and to meet specifications of electrical devices. Solar photovoltaic (PV) cells inherently produce DC output which sometimes needs to be converted to AC, such as when being stepped up to feed the grid or to power industrial and consumer devices, such as computers, appliances, etc. This can be accomplished by using an inverter that employs power semiconductors which convert the DC to AC. Another option is to use a DC motor-AC generator combination.

Some, but not all, embodiments herein are generally directed to producing NESDC (Not Essentially Steady Direct Current) without the need for power semiconductors as are used in inverters today. For example, embodiments herein may, but are not necessarily required to, be implemented in part mechanically so as to produce NESDC, e.g., AC (any wave form), pulsed or variable (periodic or not), intermittent (periodic or not), a combination of AC and DC (any wave form), or separate or combined generation of both.

By passing a shadow between a radiation (e.g. light) source and a convertor (a photovoltaic cell or other device that converts radiation into electrical current), such as a photovoltaic cell, thermovoltaic cell, micro TEG device (low thermal mass) etc., current from the convertor can be turned on or off, to the extent shown in U.S. patent application Ser. No. 12/566,327 and Ser. No. 61/194,114, both of which are incorporated by reference herein as if fully stated. However, improving thereon, there can be one or more convertors located to produce NESDC by repeatedly shadowing the convertor from exposure to radiation such that at least some of the radiation shadowed from the convertor either produces electricity or is reflected to an emitter which subsequently reemits radiation to the convertor.

In some embodiments, a device (a vane which intermittently interrupts radiation to a convertor so that the convertor intermittently produces current) employs at least one reflector that reflects some of the interrupted radiation back to the emitter or to another emitter. This reflected radiation serves to heat the emitter (and/or another emitter) and thus is not “wasted.” Therefore, less fuel or energy is required to maintain the emitter at a given temperature. To exemplify, consider an implementation in which reflectors intercept 50% of the emitted radiation and reflect that radiation back to the emitter, while the other 50% is received by one or more convertor to produce NESDC. While the power output is reduced by 50%, less fuel or energy is required to maintain the emitter at a given temperature. However, in another configuration, while shadowing one convertor, a reflector can intercept 50% of the emitted radiation and reflect that radiation to another convertor, to produce NESDC. In the case where the entire vane is coated in convertors that produce DC, all of the light is utilized to produce either DC or NESDC electricity and no shadowing reflector is utilized. Reflectors are still possibly utilized in the design of the convertors and a mounting structure for them. Thus reflectors can be used to improve efficiency and lower heat load by filling gaps between convertors and covering electrical leads and other non-Converter materials such that any radiation that is incident upon them is reflected back to the emitter or a further convertor.

In some configurations, oscillating or rotating vanes can be employed to shadow the convertor(s) and support the reflectors. By varying (for example) the respective width and/or speed of the vanes, reflectors, convertors, and emitters, and by combining output from convertors, a range of NESDC frequencies can be efficiently produced. Indeed, by having convertors and/or vanes of differing widths within the same overall unit, multiple frequencies of NESDC can be simultaneously produced.

In some configurations, a convertor can be located adjacent to a reflector, and another convertor can be located on the underside of a vane, such that radiation from the emitter, angled toward the convertor that is located adjacent to the reflector produces current when not shadowed by the vane, but when shadowed, the reflector adjacent to convertor reflects the radiation up to the convertor that is located on the bottom of a vane. Thus configured, the convertor adjacent to the reflector could produce intermittent DC in one direction, and when shadowed such that the radiation instead is reflected by the reflector, the radiation produces, from the other convertor on the bottom of the vane, intermittent DC flowing in the opposite direction, collectively producing AC. Alternatively, the current from the convertors can be combined in the same direction, and in either case, produce NESDC individually or collectively.

In some embodiments, vanes can be oriented as a cylindrical “squirrel cage” with, for example, 50% of the area of the cylindrical face covered by the reflectors and 50% open to allow the radiation to pass through. When the reflective surface(s) are not 100% reflective across all wavelengths of light and infra-red radiation emitted, and the reflective surface and thus its support will heat up. This can be especially pronounced in vacuum as the only mechanisms for cooling are radiative and conductive along the support(s).

A suitable reflective material can maintain a very high reflectivity and potentially high temperatures for situations where the vane is not actively cooled or heat sunk. Suitable metals include the transition metals that can maintain a polished surface and have a high melting point. Gold and Silver are suitable where high temperatures are not encountered. Metals Tungsten, Molybdenum, Rhenium, Osmium, Iridium, and Platinum can be used for higher temperature reflectors, as can ceramics.

A rear surface of the vane will be facing the convertors in some configurations. This rear surface can be hot and can radiate towards the convertor. Where a shadow is desired, the emission temperature can be kept low.

One series of embodiments can have a backing for the reflective material that is substantially thermally conductive, e.g., copper, aluminum, or some other metal or alloy. The backing can be thermally in communication with a cooling system, e.g., the backing containing a circulating fluid or being thermally connected to a cooled heat sink.

Another series of embodiments, which can be used independently or in conjunction with an active or passive cooling system, has a high emissivity rear surface to allow a vane to radiate heat efficiently and lose energy through radiation cooling. The choice of a material having a high emissivity, such as carbon, allows the vane to radiate at a relatively low temperature. Resultant emission can then be below a threshold for electron production in the convertor, thus maintaining the shadowing effect.

Further embodiments incorporate one or more convertors placed on a rotating surface that is not occluded by the vanes, thus producing DC from the rotating convertors and AC from the fixed and periodically shadowed convertors, e.g., in applications where both DC and AC power are needed for a generator and/or load.

In further embodiments, additional vanes can be placed between the convertors and the emitter(s) such that up to essentially 100% of the emitted light is reflected back. If all the vanes are closed they will behave like a venetian blind. This enables the device to be placed in standby; maintaining a given temperature for the minimum amount of fuel. In this mode the unit could be considered to be blanketed or in “idle” mode. Such a standby mode could reduce the amount of fuel being consumed and allow for an essentially instantaneous startup or a faster start up than is feasible from cold.

When the unit is synchronized to operate in conjunction with other devices or the grid, a motor or other means driving the rotating vanes can be controlled with a control circuit or a feedback device to ensure that the frequency and phase of the output electricity complies with the required performance.

In some embodiments, the rotating vane(s) may be placed inside an evacuated enclosure. The amount of energy required to maintain the rotation will only need to overcome bearing friction as there will be no air resistance. The amount of power used to perform this function can be trivial compared with the power produced by the unit, will largely be independent of the power of the unit, and also will be largely independent of the throttling of the emitter.

As the shadow sweeps across the convertor, the amount of current output from the convertor will decline until it reaches zero, if the convertor is completely shadowed from the emitter. As the shadowing device continues to move past the convertor, the current will again begin to flow and reach a maximum once the shadow has been removed.

The shape of the waveform can be adjusted by varying the shape of the shadowing device. The shadow can be swept across the convertor in a linear fashion with the edge parallel to a square or rectangular convertor, but other configurations can be implemented. For example, an embodiment can have a shadowing device that crosses the convertor at an angle or curve (e.g., 45 degrees) so as to initially cover a small portion of the convertor and gradually cover more and more at an increasing rate. Once 50% of the convertor is covered, the reverse effect can occur with the trailing edge as the remaining 50% is swept. This approach can be implemented so as to create any desired waveform. In the case of the 45 degree sweep over a square area, an approximately sinusoidal form is output. If a differing waveform is desired, for example to drive a particular motor or load, the shape and/or slope of the shadow can be configured or even adjusted, as can the shape and/or slope of the convertor, etc.

In some embodiments, convertors can be connected with opposite polarity to achieve alternating current. For example, sinusoidal AC could be produced by having two oppositely wired convertors mounted back-to-back that spin at a constant rate so that the convertors are alternately exposed to the emitter. AC could also be produced by connecting the output of a DC convertor to a transformer, with the DC convertor alternately illuminated by the emitter and then shadowed.

To simplify the teachings of this specification, certain conventions are used. Consider that a way of articulating the shadowing with respect to a convertor is to view a convertor as stationary and a means for shadowing the convertor as moving so as to interrupt a path of radiation from an emitter to the convertor, e.g., vanes (like those on a windmill) rotate to interrupt a path of radiation from an emitter to a convertor. However, this perspective is arbitrary, and one could equally view the convertor as moving through a stationary shadow, e.g., the vanes being stationary while the convertor moves in and out of the path of radiation from the emitter. One could equally view the convertor and the means for shadowing as both moving oppositely, i.e., neither is stationary. Even yet further, one could equally view the emitter moving instead, or in combination with, movement of the convertor and reflector. In view thereof, only for the sake of consistency and simplification, this specification will at times, but not always, adopt the convention of referring to the emitter and the convertor as being stationary, with the explicit understanding that in many embodiments, they are not. Similarly, a teaching herein with respect to a particular emitter 4, convertor 6, reflector 8, or vane 5 (each in the singular) is applicable to each in the plural, e.g., emitters 4A, 4B, etc., convertors 6A, 6B, etc., reflectors 8A, 8B, etc., and vanes 5A, 5B, etc. Again only for the sake of consistency and simplification, this specification will at times, but not always, adopt the convention of using the singular, with the explicit understanding that in many embodiments, they are not. Additionally, the emitter can be an emitter of light, heat, and/or other radiation, and correspondingly, a convertor can be a photovoltaic (PV) cell, thermovoltaic (TV) cell, etc. In some embodiments, the emitter can be comprised of a hot emitter and the convertor can be one or more photovoltaic cells that convert the emitted radiation into electric power, such as in a non-limiting example as disclosed in Ser. No. 60/833,335; 60/900,866; Ser. No. 11/828,311, and Ser. No. 12/375,176, all of which are incorporated by reference as if fully restated herein.

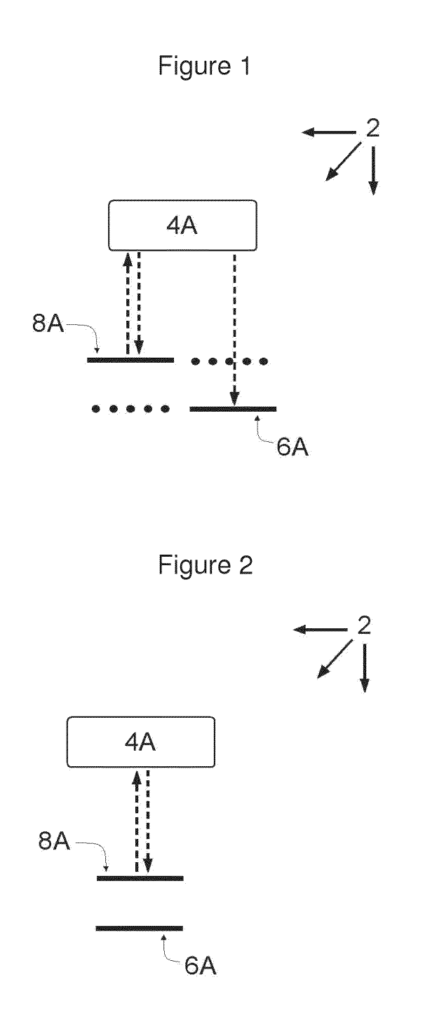

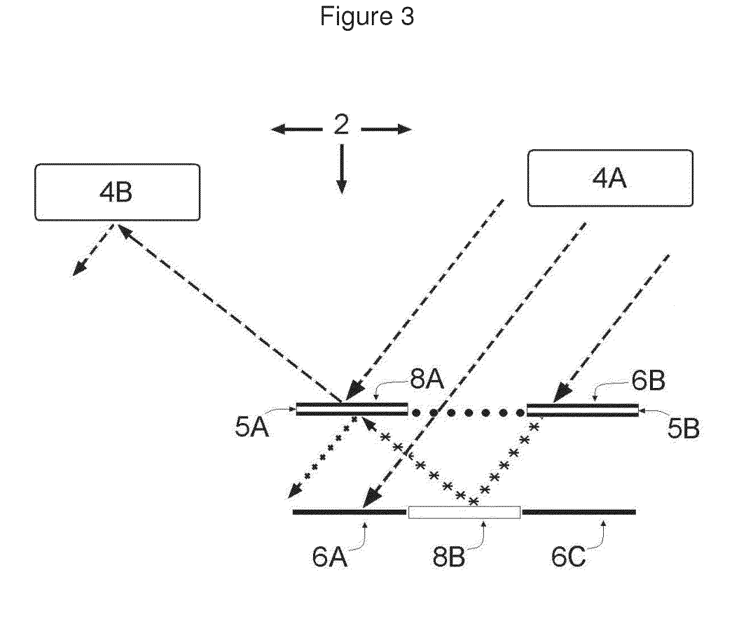

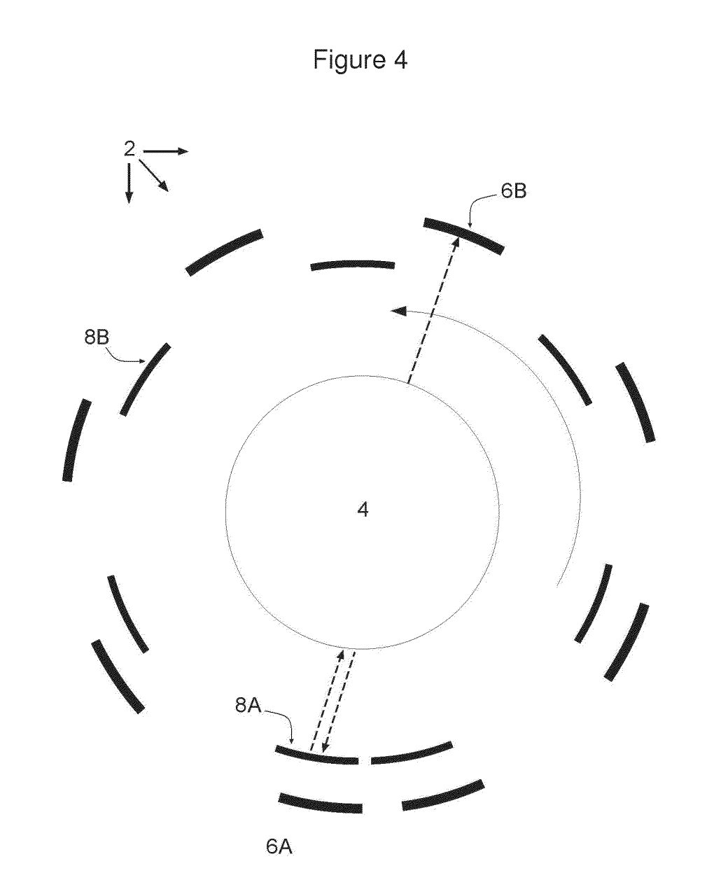

With this in mind, then, turn now to the figures, wherein FIG. 1 is to teach, illustratively, embodiments in which emitter 4A communicates some radiation (dashed lines) to convertor 6A, which produces current therefrom. Also illustrated in this teaching example, is that reflector 8A can, but need not at this point, reflect at least some radiation back to be received by the emitter 4A, or in some embodiments, to another emitter 4 (see FIG. 3). The emitter 4A in FIG. 1 absorbs at least some of the reflected and received radiation and reemits at least some of the absorbed radiation in a re-emission which at least in part is received by convertor 6A, or in other embodiments, to another convertor (see FIG. 3). The dotted lines in FIG. 1 are to suggest where there can be a change in orientation of convertor 6A with respect to reflector 8A best understood in connection with FIG. 2.

FIG. 2 is to teach, illustratively, embodiments in which there has been a change in orientation, e.g., carried out by oscillating the reflector 8A, the convertor 6A, or both with respect to each other. (Alternative embodiments can use rotation or other movement instead of, or in combination with, the oscillating.) In FIG. 2, reflector 8A now shadows convertor 6A from the path of radiation from emitter 4A. At this point, for this teaching example, convertor 6A is not producing current, while reflector 8A is reflecting essentially all radiation back to emitter 4A. Though not shown in FIGS. 1 and 2, it is to be understood that there would be intermediate locating of the reflector 8A and convertor 6A in going from the locations illustrated in FIG. 1 to the locations illustrated in FIG. 2.

FIGS. 1 and 2 collectively illustrate a current producing apparatus which includes a convertor 6A located to produce current that is not NESDC by repeatedly shadowing convertor 6A, e.g., by changing the respective orientation of reflector 8A vis-a-vis convertor 6A, as in moving repeatedly from FIG. 1 to FIG. 2 back to FIG. 1, etc. The shadowing of convertor 6A from exposure to radiation (the dashed line) is such that at least some of the radiation shadowed from the convertor 6A is reflected to an emitter 4A (in FIG. 2) which subsequently reemits radiation to the convertor 4A after the shadowing produced by reflector 8A changes in orientation with respect to the convertor 6A, as illustrated by returning to the orientation in FIG. 1.

FIG. 3 is to teach, illustratively, embodiments in which reflection and detection can otherwise be implemented. For example, there can be an orientation such that a portion of the radiation (dashed lines) from the emitter 4A is reflected by reflector 8A to another emitter 4B for re-emission directed to be received by another convertor (not shown in FIG. 3). Another portion of the radiation from the emitter 4A is received by convertor 6A, and yet another portion of the radiation from emitter 4A is received by convertor 6B, the convertors 6 each producing current.

There can be one or more vanes 5 disposed for movement which produces the shadowing. In some implementations, a vane 5 can support or be comprised of at least one reflector 8, e.g., 8A mirrored to reflect the radiation to the emitter 4A. In some implementations, a vane 5 can support or be comprised of at least one convertor, e.g., convertor 6B. When the orientation with respect to vane 5A changes toward the position of the dotted line and onward, eventually convertor 6A will be shadowed from the path of radiation from emitter 4A, and reflector 8B will reflect the radiation up to the emitter 4B, following a path in part suggested by the asterisked lines, while convertor 6C would be exposed to the radiation path from emitter 4A.

While FIG. 3 is to teach embodiments in which vane 5A supports or comprises reflector 8A and vane 5B supports convertor 6B, an alternative configuration (not shown in FIG. 3) is to instead have vane 5B support a reflector 8, such that the movement would bring it into a position to reflect a path of radiation back toward emitter 4A.

As an additional teaching, (not shown in FIG. 3) consider that each of vanes 5A and 5B could have a face upwards, generally toward the emitters 4A and 4B and a face downwards, generally toward convertor 6A and reflector 8B. The downwards faces can each be configured to support another convertor. That is, the vanes 5A and 5B and the convertor 6A and reflector 8B can be oriented such that the paths of radiation from emitter 4 are at times reflected by reflector 8B to one of the other convertors on one of the bottom faces of the vanes 5A and 5B.

Alternatively, (not shown in FIG. 3) consider that the downwards faces of vanes 5A and 5B can each be configured to support another reflector. The vanes 5A and 5B and the convertors 6A and reflector 8B can be oriented such that the paths of radiation from emitter 4 are at times reflected by reflector 6B to one of the other reflectors on one of the bottom faces of the vanes 5A and 5B and then on, as suggested by the + line in FIG. 3, to either another emitter or another convertor. Variations combining alternate convertors and reflectors are also embodiments varying the themes disclosed herein. In any case, FIGS. 1-3 are to teach, illustratively, that in one configuration or another, at least some of the radiation shadowed from the convertor 6A either produces electricity or is reflected to an emitter (4A or 4B, etc.) which subsequently reemits at least some of the radiation to the convertor (6A) or to another convertor (6B, etc.) or to both. Also, whether by the convertor 6 comprising a thermovoltaic cell, a photovoltaic cell, or otherwise and in any combination thereof, i.e., there can be a plurality of convertors 6, at least one convertor is disposed to produce intermittent current.

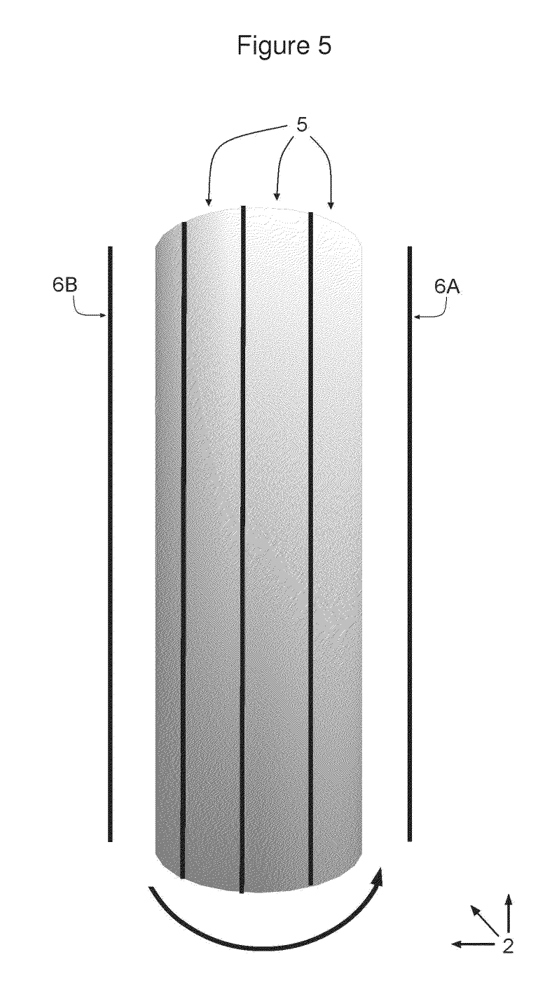

FIG. 4 is to teach, illustratively, embodiments in which rotation is employed to carry out at least some of the change in orientation and shadowing. In this overhead view, emitter 4 can have reflectors 8A, 8B, etc. rotating on vanes (not enumerated in FIG. 4) on an inner circumference shadowing at least one of the convertors 6A so as to be either reflecting radiation back toward emitter 4 for the re-emitting or allowing a path of radiation to be received by at least one of the convertors 6B.

As an alternative, or in combination with the rotation, the configuration in FIG. 4 also illustrates that there can be another manner of oscillating, e.g., in one axial direction and then the other, such that, though not shown in FIG. 4, the reflectors 8/convertors 6 bring about the shadowing effect by respective axial movement.

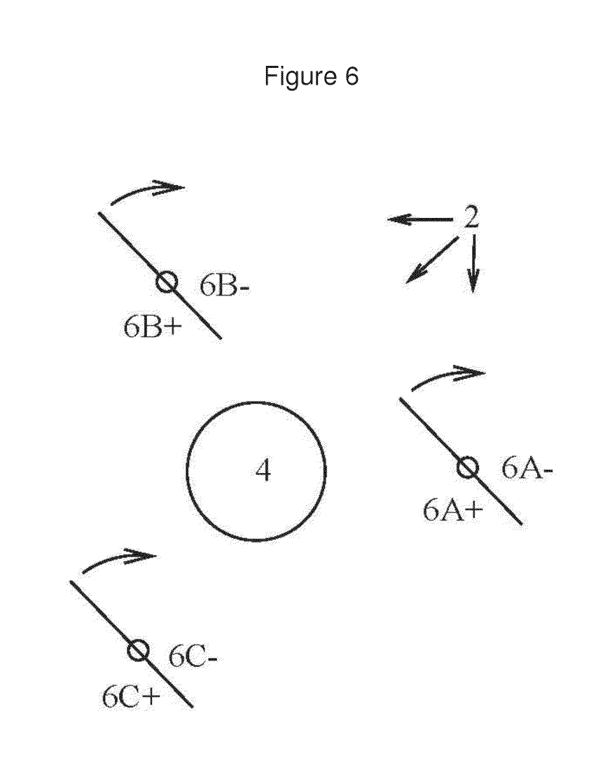

FIG. 5 is to teach, illustratively, embodiments in which there is a standby mode. In this mode, vanes 5 have been withdrawn inwards toward the emitter 4 so as to reflect all emission from emitter 4 (not shown in FIG. 5) back to toward the emitter 4 rather than allow a path of radiation to convertors 6A and 6B. Such a standby mode can be used, for example, to reduce the amount of fuel being consumed to power emitter 4 but allow for an essentially instantaneous startup by controllably opening the vanes 5 like Venetian blinds or moving the vanes outwards from their axis to controllably open sufficiently to allow paths of radiation from emitter 4 to be communicated to convertors 6A and 6B. Other methods of closing the reflectors are possible. For example, a telescoping system or a series of unfurling petals would also achieve a similar result.

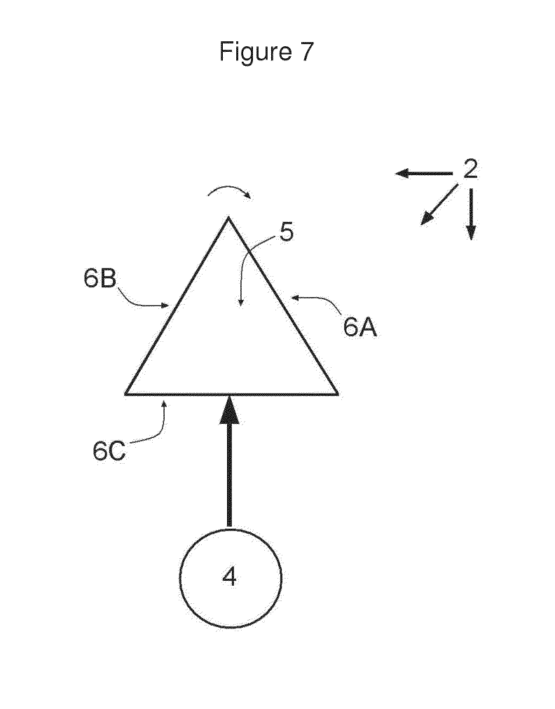

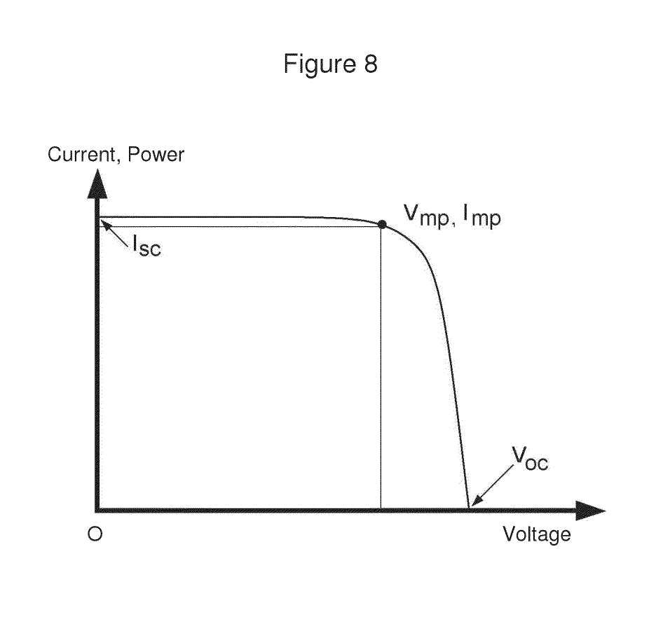

FIG. 6 is to teach, illustratively, that the orientation of the convertors 6 can be configured to produce a current voltage curve and an NESDC predefined by an operable range of an electrical device. For example, though not shown in FIG. 6, embodiments can use periscoping or telescoping to bring one reflector 8 or set of reflectors 8, or convertor 6 or set of convertors 6 into operational position(s) over others. Instead, FIG. 7 illustrates three pairs of convertors (6A+ & 6A−, 6B+ & 6B−, and 6C+ & 6C−) rotating in lock step with each other. Each pair of convertors is wired to produce current in the opposite direction, so that each pair produces a sine wave as it rotates with constant angular velocity. Because the three pairs of converters are evenly spaced around the emitter 4, the phase of the sine wave for each pair will differ from the other two pairs by 2π/3, and the resultant output can be such as to approximate three-phase current.

FIG. 7 illustrates that, again depending on the configuration preferred in one embodiment or another, a tube (i.e., vane 5) and/or the emitter 4 can be moved into or out of the path of the radiation, e.g., by periscoping or telescoping the tube in an axial direction, and similarly, in some other embodiments, reflectors 8 can instead be on faces of a triangular tube, with convertors 6 located to receive a path of radiation reflected thereby. Indeed, there can be a myriad of combinations by shaping the vane 5 to influence the NESDC.

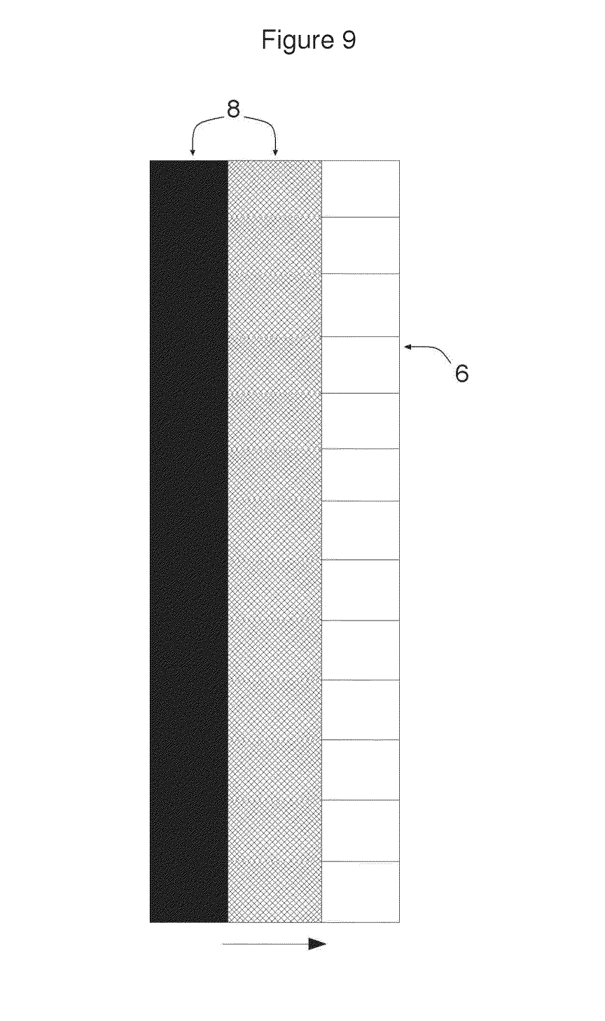

Illustratively with respect to a diode configuration, FIG. 8 shows an IV curve in which voltage (V) is graphed with respect to current (I) for an understanding of shadowing with respect to the leading edge of the shadowing and interplay between the leading edge and the IV curve, and how this shapes the overall output, voltage, and power. The maximum power (mp) for a convertor occurs at the Vmp, Imp point, i.e., where the area under the curve is a maximum for V×I. The Isc (short circuit) and Voc (open circuit) show the maximum current and voltage attainable at those two extremes. The dominant effect of shadowing is to reduce Isc and Imp, which in turn reduces the maximum power the convertor can produce.

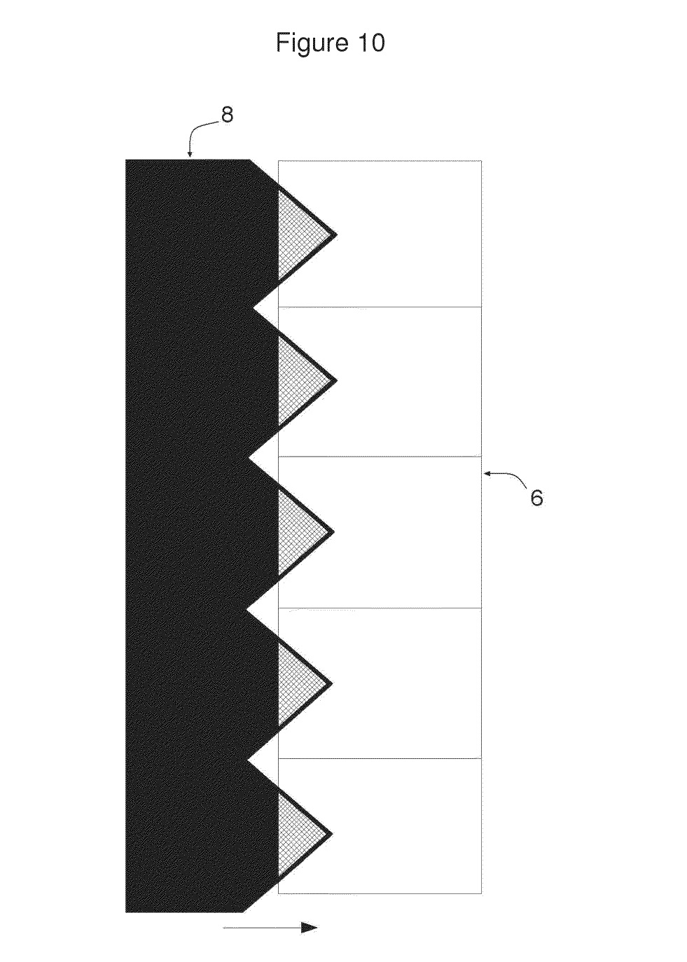

FIG. 9 is to teach, illustratively, that the shape of the vane 5 can be configured to produce a current voltage curve and an NESDC predefined by an operable range of an electrical device. In FIG. 9, we see that the shape of the edge of the vane 5 is a controllable variable to influence the NESDC. The edge may be the leading edge, trailing edge, or both for a vane 5 (and thereby influencing the shape of the shadowing of convertor's 6), and/or the leading edge, trailing edge, or both for the edge of a reflector 8. For example, the edge can be located to produce the shadowing or reflecting or both, and the edge can be shaped to cause a surface of the convertor 6, and/or reflector 8, to be progressively shadowed so as to produce a current voltage curve predefined by an operable range of an electrical device, e.g., with a saw toothed, perforated, or curved edge. Illustrative of the first of these embodiments, in FIG. 9, a rectangular leading edge of vane 5, and correspondingly reflector 8, is positioned to shadow much of a set of convertors 6. In FIG. 9, the black and crosshatched areas are indicative of the vane 5 and the reflector 8, while the crosshatched area corresponds to a shadow cast by the vane 5 over some of the convertors 6. One may imagine from FIG. 9 an alternative configuration in which the black and crosshatched areas are indicative of the vane 5, the crosshatched area corresponds to a shadow cast by the vane 5 over some of the convertors 6, and the black area corresponds to the reflector 8. That is, reflector 8 can, but need not, be configured to match the leading and trailing edges of vane 5. Further, though not shown in FIG. 9, the angle of the vane 5 and/or reflector 8 can be adjustable or changing so that the rate and/or amount of shadowing produces adjustable variations in the NESDC. And while FIG. 9 is presented with respect to a leading edge, the same teaching is applicable if the edge were a trailing edge.

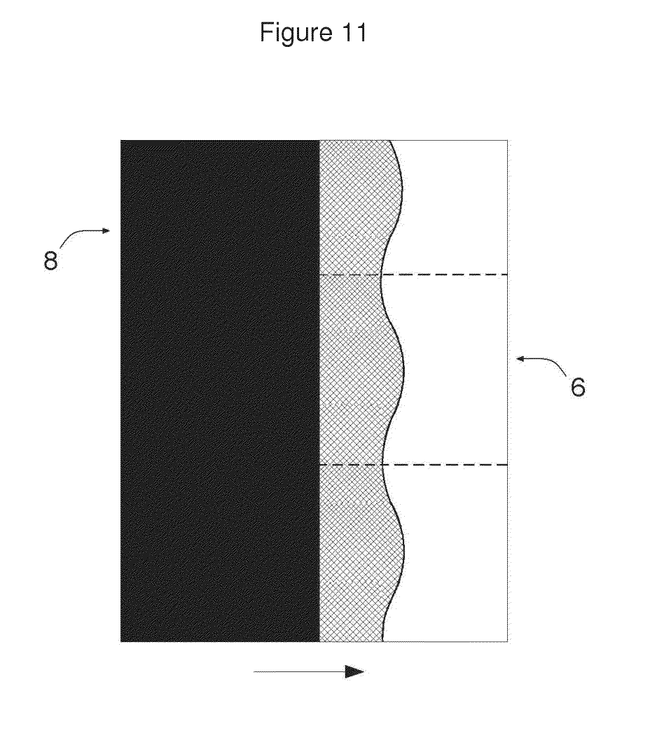

FIG. 10 is to teach, illustratively, that the vane 5 can have a different shape than that in FIG. 9. In the case of FIG. 10, a saw-tooth leading edge of vane 5 and thus shadowing is positioned over much of a set of convertors 6. Again, as may be desired in one configuration or another, reflector 8 can coincide with either the black area of FIG. 10 or the black and crosshatched area. Indeed, if so desired, the reflectors 8 could coincide with only the crosshatched areas. The respective shapes of the vane edges will influence the shape of the current output by the convertors 6 subjected to the shadowing, and the shapes of the reflectors 8 will influence the shape of the current output by convertors 6 that receive the radiation reflected by the reflectors 8. The leading edges and trailing edges need not be the same, and thus, for example, a configuration may have a leading rectangular edge as in FIG. 10 but a saw tooth trailing edge of FIG. 9.

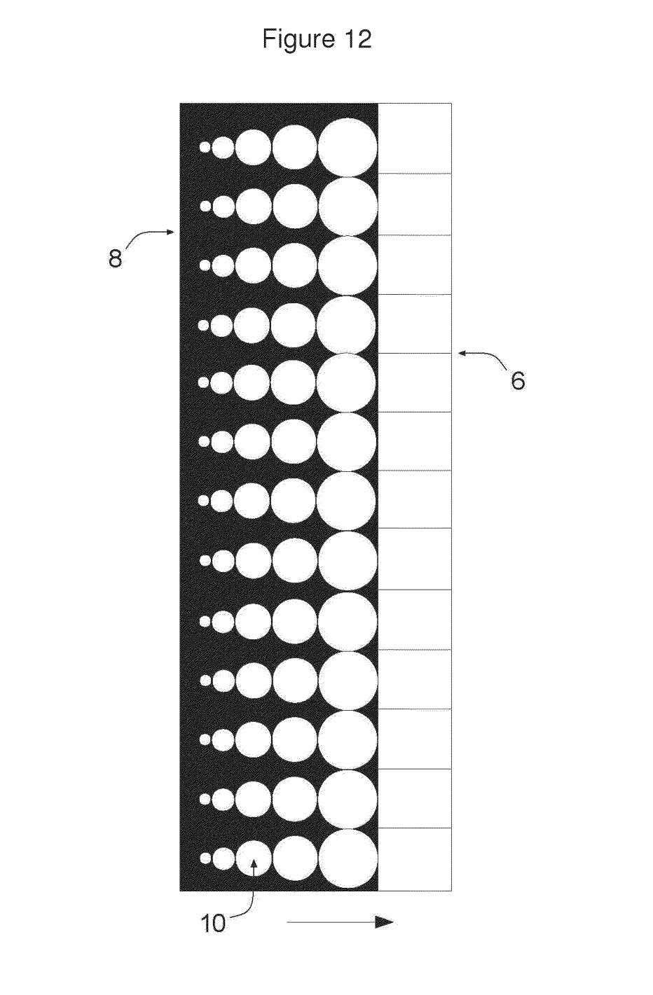

FIG. 11 is to teach, illustratively, that the vane 5 can have a different shape than either of those taught with respect to FIGS. 9 and 10. FIG. 11 illustrates a curvilinear edge for vane 5, to produce reflecting capability as well as shadowing of the convertors 6 as discussed with respect to FIGS. 9 and 10. Leading edges and trailing edges of vane 5, and/or reflector 8 can be configured to influence the shape of the NESDC from the unit 2.

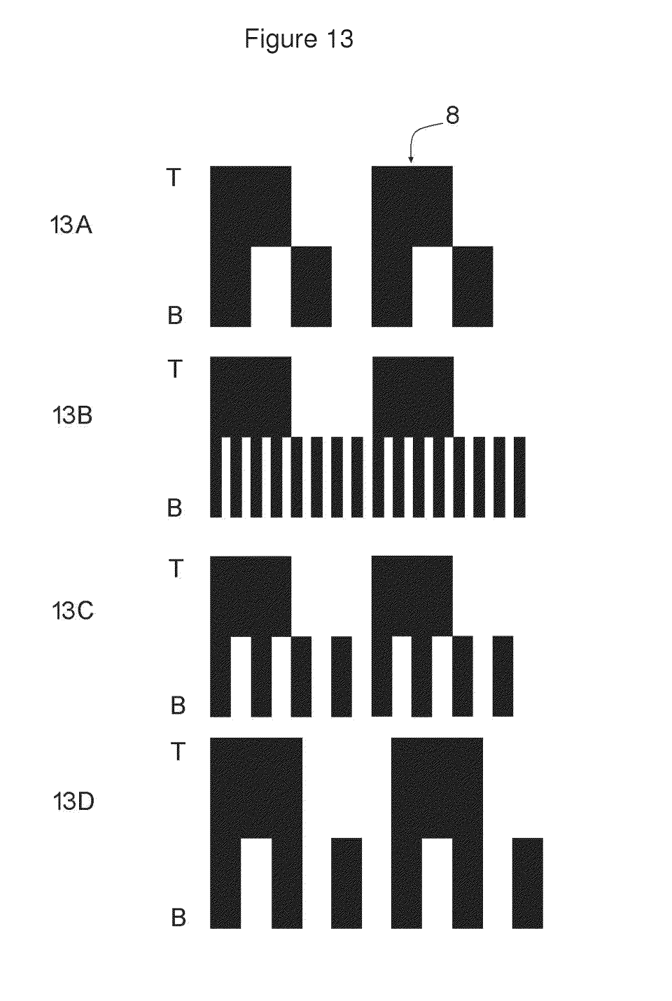

FIG. 12 is to teach, illustratively, embodiments in which the vane 5 can have one or more radiation openings or portals 10 that thereby influence shadowing of convertors 6. Openings and edge shapes can be used individually or collectively to influence the NESDC.

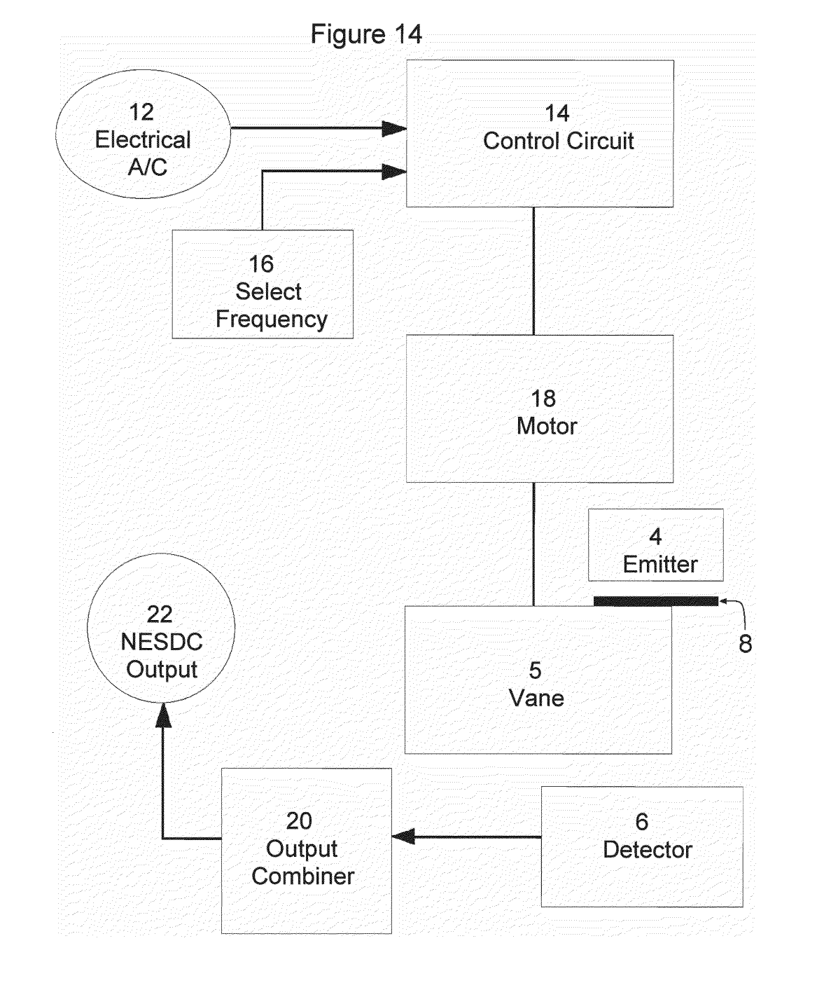

FIG. 13 is to teach, illustratively, various ratios of vanes 5 shadowing areas and open areas. Open areas and narrow convertors (not shown in FIG. 1) can provide a high frequency voltage variation, and wider convertors and narrow open areas provide lower frequency variation for a given rotation speed. FIGS. 13A, 13B, 13C, 13D, each combine shadowing areas and open areas to illustrate frequency multiples. The lower periodicity section (arbitrarily designated T for top) in FIG. 13A has two shadowing areas separated by one and one-half light areas; the higher periodicity section (arbitrarily designated B for bottom) has four shadowing areas separated by three open areas. That is, the higher periodicity section is two times the frequency of the lower periodicity section. FIGS. 13B, 13C, and 13D, illustrate combinations of other frequencies, i.e., eight times, four times, three times, respectively. Other combinations of frequencies can be used if so desired. Such vane 5 configurations can be used individually, selectively, or collectively, as may be desired for a particular application, thereby illustrating capacity for a wide range of frequency variations. Accordingly, the shadowing can be carried out by one or more rotating reflector 8 vanes 5 spaced, rotated, and configured so that the unit produces multiple frequencies of the intermittent current. Also accordingly, either the convertor 6 and another convertor or a plurality of reflectors 8 can be disposed to produce the shadowing, such that a varied length, width, or both produce multiple frequencies of the intermittent current.

FIG. 14 is to teach, illustratively, other components that may, if desired, be employed. Electrical current (e.g., AC) can be input to a control circuit 14 configured, if so desired, to receive input from a device configured to select frequency 16. The control circuit 14 has the capacity to select the speed at which the vanes 5 will move, e.g., based on user selection, feedback from a device such as a motor, a detection from the grid, etc. Thus, control circuit 14 has the capacity to synchronize the speed so as to be in operable association with an external alternating current, etc.

For example, the control circuit 14 can include a frequency generator, such as a crystal oscillator. In this case the select frequency 16 could be a number by which the frequency generator output is divided by to set the frequency of the signal to the motor 18. For example, the frequency generator could generate a 1 MHz signal, and the select frequency 16 input could be the number 10000, so that the frequency sent to the motor 18 would be 1 MHz/10000=100 Hz. Depending upon the design of the motor 18, it could then rotate at 100 Hz, or perhaps at half the input frequency, 50 Hz. In other embodiments, the input frequency could be derived from the electrical A/C 12 input. A particularly simple embodiment of the control circuit 14 is to drive the motor 18 directly from the electrical A/C 12 input so that the motor 18 remains phase locked with the input electrical A/C 12. In some other embodiments, the Control Circuit 14 could receive feedback from the detector 6 (feedback not shown in FIG. 14), and make adjustments to the control signals sent to the motor 18 based upon this feedback.

Control circuit 14 governs motor 18 having a shaft that, in this teaching example, has vanes 5. Vanes 5 rotate to interrupt the path of radiation communicated from emitter 4 toward convertors 6 with reflectors 8, which reflect the radiation toward emitter 4 for being re-emitted so as to be received by convertors 6. Convertors 6 produce current that is communicated to output combiner 20, which combines the current from convertors 6 so as to produce the output 22, i.e., NESDC. Though not shown in FIG. 14, metering can be applied to output 22 so as to measure the quantity of electricity output to, for example, the grid.

The configuration of output combiner 20 may, to a degree, reflect the particular implementation desired. Consider, for example, an embodiment that could be used to produce 3-phase current from the apparatus shown in FIG. 6. The output combiner 20 in this embodiment could have twelve inputs: two from each of the six detectors 6A+, 6A−, 6B+, 6B−, 6C+, and 6C−, and four outputs, A, B, C, and N, although N is optional for a balanced system. The inputs from each of the detectors 6 have a positive and a negative. The positive input from 6A+ and the negative input from 6A− would be connected to output A, while the negative input from 6A+ and the positive input from 6A− would be connected to N. Similarly, the positive input from 6B+ and the negative input from 6B− would be connected to output B, while the negative input from 6B+ and the positive input from 6B− would be connected to N. Finally, the positive input from 6C+ and the negative input from 6C− would be connected to output C, while the negative input from 6C+ and the positive input from 6C− would be connected to N. Other embodiments could be more or less complex as necessitated by the desired waveform and the desired number of phases.

The motor 18 can, but need not, be in the form of an induction motor with coils internal or external to the unit 2, i.e., an induction motor can be oriented to move the vanes 5 without direct electrical contact. The motor 18 can bring about the shadowing by rotating one or more rotating vanes 5 spaced and rotated at a speed that produces the intermittent current at a frequency between and including 10,000 and 100 megahertz, between 1 and 10,000 hertz, at 400 hertz, at 60 hertz, or at 50 hertz, depending on the configuration and use desired for one application or another. By utilizing hair thin devices and a fast rotation speed, surprisingly high frequencies are attainable up to at least 1 gigahertz. By utilizing standard semiconductor chip production methods, very narrow PV cells can be manufactured adjacent on the same substrate thus allowing for very high frequency NESDC if desired.

If the motor is powered off of the grid, the rotation can be in phase with the grid and this will enable the resulting NESDC to also be in phase with the grid.

The reflector 8 may, if desired, have an insulating or cooled backing. The backing, if so desired, may comprise molybdenum, silver, gold, tungsten, for communicating heat. The backing, if so desired, may comprise an insulating backing, such as a backing which includes zirconia, alumina, silicon carbide, magnesium oxide, a ceramic, etc.

Note that the necessity or suitability of components for one embodiment or another will depend on the particular implementation desired. So for example, there can be an implementation along the lines of a Crookes radiometer configuration, illustrating that an emitter, like the sun, can cause rotation of the convertors and/or reflectors. In this configuration, there would be no need for a motor. The point of this teaching is that the necessity or suitability of components depends on the particular implementation that is desired.

In any case, the relative size, spacing, shape, angle, speed of rotation, and/or speed of oscillation of the vanes 5 with respect to the convertors 6, etc. can each individually or in any combination thereof, determine the shape and frequency of the varying current produced by the unit 2. Similarly, the relative size, spacing, shape, angle, speed of rotation, and/or speed of oscillation of the reflectors 5 with respect to the convertors 6, etc. receiving reflected radiation can each individually or in any combination thereof determine the shape and frequency of the varying current produced by the unit 2. Further, there are other ways to enable selection of the current output, e.g., relative size of the unit and its components, the percentage shadow coverage at each point during movement. For example, the rate of movement and the rate of acceleration with respect to the change in orientation can drive a particular waveform when convoluted with the power curve for the convertor 6. Illustratively, then, unit 2 can be configured to produce AC, e.g. by having oppositely wired convertors alternately exposed to the emitter, AC with a substantially sinusoidal wave form, e.g., by having two oppositely wired convertors mounted back-to-back that spin at a constant rate so that the convertors are alternately exposed to the emitter; DC, e.g., by having a convertor on a vane continuously exposed to the emitter; intermittent DC, e.g., by arranging convertors so there are periods of time when all convertors are shadowed; variable DC, e.g., by having convertors arranged variably, and/or by having vanes arranged variably; periodic DC, e.g., by having convertors arranged periodically, shadowed by periodic vanes that rotate at a constant rate; AC separate from the DC, e.g., by having convertors mounted on vanes to provide DC, and having alternately exposed convertors wired oppositely to provide AC; DC and AC, such that at least one of the DC and AC is variable, e.g., by having the convertors arranged variably; DC and AC, such that at least one of the DC and AC is pulsed.

In sum, appreciation is requested for the robust range of possibilities flowing from the teachings herein. More broadly, however, the terms and expressions which have been employed herein are used as terms of teaching and not of limitation, and there is no intention, in the use of such terms and expressions, of excluding equivalents of the features shown and described, or portions thereof, it being recognized that various modifications are possible within the scope of the embodiments contemplated and suggested herein. Further, various embodiments which implement the general teachings are to be viewed as included herein because the disclosure herein has been described with reference to specific embodiments for teaching purposes, such that the disclosures are intended to be illustrative and are not intended to be limiting. Various modifications and applications may occur to those skilled in the art without departing from the true spirit and scope defined in the claims.

Thus, although only a few exemplary embodiments have been described in detail above, those skilled in the art will readily appreciate that many modifications are possible in the exemplary embodiments without materially departing from the novel teachings and advantages herein. Accordingly, it is respectfully requested that all such modifications be included within the scope defined by claims. Means-plus-function language and claims, if any, are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment fastening wooden parts, a nail and a screw may be equivalent structures.

1. A current producing apparatus, the apparatus including:
a convertor located to produce current that is not essentially steady direct current by repeatedly shadowing the convertor from exposure to radiation such that at least some of the radiation shadowed from the convertor either produces electricity or is reflected to an emitter which subsequently reemits at least some of the radiation to the convertor or to another convertor or to both.

2. The apparatus of claim 1, wherein the convertor comprises a thermovoltaic cell.

3. The apparatus of claim 1, wherein the convertor comprises a photovoltaic cell.

4. The apparatus of claim 3, wherein said at least some of the radiation shadowed from the photovoltaic convertor produces the electricity.

5. The apparatus of claim 1, further including a vane disposed for movement which produces the shadowing, wherein the vane supports at least one photovoltaic convertor.

6. The apparatus of claim 1, further including a vane disposed for movement which produces the shadowing, wherein the vane is mirrored to reflect the shadowed radiation to the emitter.

7. The apparatus of claim 5, wherein the vane is configured to produce a voltage curve predefined by an operable range of an electrical device operably associated with the apparatus.

8. The apparatus of claim 6, wherein the vane is configured to produce a current voltage curve predefined by an operable range of an electrical device operably associated with the apparatus.

9. (canceled)

10. The apparatus of claim 5, further including a vane disposed for movement which produces the shadowing and an induction motor oriented to move the vane without direct electrical contact.

11. The apparatus of claim 5, further including an edge located to produce the shadowing, wherein the edge is shaped to cause a surface of the photovoltaic convertor to be progressively shadowed so as to produce a current voltage curve predefined by an operable range of an electrical device.

12. The apparatus of claim 11, wherein the edge is a saw toothed, perforated or curved edge.

13. The apparatus of claim 3, wherein the current producing apparatus is configured to produce AC.

14. The apparatus of claim 13, wherein the AC has a substantially sinusoidal wave form.

15. (canceled)

16. (canceled)

17. (canceled)

18. (canceled)

19. The apparatus of claim 3, wherein the current producing apparatus is configured to produce DC.

20. (canceled)

21. (canceled)

22. (canceled)

23. (canceled)

24. (canceled)

25. The apparatus of claim 22, wherein the current producing apparatus is configured to produce AC separate from the DC.

26. (canceled)

27. (canceled)

28. (canceled)

29. (canceled)

30. The apparatus of claim 1, further including a Molybdenum obstruction disposed for movement which produces the shadowing.

31. The apparatus of claim 1, further including a silver obstruction disposed for movement which produces the shadowing.

32. The apparatus of claim 1, further including a gold obstruction disposed for movement which produces the shadowing.

33. The apparatus of claim 1, further including a tungsten obstruction disposed for movement which produces the shadowing.

34. The apparatus of claim 1, further including an obstruction with an insulating backing, the obstruction disposed for movement which produces the shadowing.

35. The apparatus of claim 34, wherein said insulating backing includes zirconia.

36. The apparatus of claim 34, wherein said insulating backing includes alumina.

37. The apparatus of claim 34, wherein said obstruction includes silicon carbide.

38. The apparatus of claim 34, wherein said obstruction includes magnesium oxide.

39. The apparatus of claim 34, wherein said insulating backing includes a ceramic.

40. The apparatus of claim 3, wherein the shadowing is produced by an obstruction which comprises one or more rotating mirrored vanes spaced and rotated at a speed that produces the intermittent current at 50 hertz.

41. The apparatus of claim 3, wherein the shadowing is produced by an obstruction which comprises one or more rotating mirrored vanes spaced and rotated at a speed that produces the intermittent current at 60 hertz.

42. The apparatus of claim 3, wherein the shadowing is produced by an obstruction which comprises one or more rotating mirrored vanes spaced and rotated at a speed that produces the intermittent current output at 400 hertz.

43. The apparatus of claim 3, wherein the shadowing is produced by an obstruction which comprises one or more rotating mirrored vanes spaced and rotated at a speed that produces the intermittent current output at any frequency between 1 and 10,000 hertz.

44. (canceled)

45. (canceled)

46. (canceled)

47. The apparatus of claim 3, wherein the shadowing is produced by rotating mirrors having a speed synchronized with, and in operable association with, an external alternating current.

48. (canceled)

49. (canceled)

50. The apparatus of claim 3, further comprising a control circuit configured for selecting the speed at which the vanes will move.

51. A current producing apparatus, the apparatus including means for producing current that is not essentially steady direct current by repeatedly shadowing a convertor from exposure to radiation such that at least some of the radiation shadowed from the convertor either produces electricity or is reflected to an emitter which subsequently reemits radiation to the convertor or to another convertor.

52. (canceled)

53. The apparatus of claim 51, wherein the convertor comprises a photovoltaic cell.

54. A method of producing current, the method including:
producing current that is not essentially steady direct current by repeatedly shadowing a convertor from exposure to radiation such that at least some of the radiation shadowed from the convertor either produces electricity or is reflected to an emitter which subsequently reemits at least some of the radiation to the convertor or to another convertor or to both.

55. (canceled)

56. The method of claim 54, wherein the producing is carried out with the convertor comprising a photovoltaic cell.

57. A method of making a current producing apparatus, the method including:
locating a convertor to produce current that is not essentially steady direct current by repeatedly shadowing the convertor from exposure to radiation such that at least some of the radiation shadowed from the convertor either produces electricity or is reflected to an emitter which subsequently reemits at least some of the radiation to the convertor or to another convertor or to both.

58. (canceled)

59. The method of claim 57, wherein the locating is carried out with the convertor comprising a photovoltaic cell.

60. An article of manufacture including:
a convertor located to produce current that is not essentially steady direct current by repeatedly shadowing the convertor from exposure to radiation such that at least some of the radiation shadowed from the convertor either produces electricity or is reflected to an emitter which subsequently reemits at least some of the radiation to the convertor or to another convertor or to both.
